(19) United States
(12) Patent Application Publication
(10) Pub. No.: US 2010/0181526 A1
(43) Pub. Date: Jul. 22, 2010

(54) NITRIC ACID BATTERY

(76) Inventor: Lawrence Wright, (US)

Correspondence Address: Lawrence Wright, 5828 W Sample Rd, 201, Coral Springs, FL, 33067, US

(21) Appl. No.: 12/355,113

(22) Filed: Jan. 16, 2009

(51) Int. Cl. H01M 4/88

(52) U.S. Cl. 252/182.1

(57) ABSTRACT

This invention discloses the method of producing a nitric acid battery suitable for high or low power applications. These batteries provide significant improvements over existing technology. The battery's cell(s) are comprised of three major components: an anode and a cathode or two electrodes of predetermined size; a primarily nitric acid (HNO₃) or nitrate (NO₃) paste or solution of predetermined molality; and a single or separated cell(s).

### TECHNICAL FIELD

The field of this invention relates to oxoacid batteries, including carboxylic, sulfuric, and phosphoric acid batteries.

### BACKGROUND OF THE INVENTION

In typical lead acid batteries, positive and negative plates composed of lead alloy and filled with active material. The lead alloy plates are used as electrodes for the cell. An alternative assembly for the battery would be comprised of two separated cells and two electrodes with predetermined molal concentrations of sulfuric acid in each cell. Though the shape and chemical composition of batteries have evolved over time, though lead-acid and lithium ion batteries are the popular today, batteries have a history dating back centuries (Pope, 2008, p. 24).

### BRIEF SUMMARY OF THE INVENTION

The object of the present invention is to overcome the environmental and degradation problems associated with current battery technology. This invention is intended to provide a nitrate battery that does not pose the same environmental dangers as of other oxoacid batteries. These batteries also have a longer shelf-life than lithium ion batteries. The resultant technology can be applied to a wide range of low to high power applications.

### BRIEF DESCRIPTION OF SEVERAL VIEWS OF THE DRAWING

FIG. 1 depicts a nitric acid (HNO₃) or nitrate (NO₃) battery distinguished by 1. an anode and a cathode or two electrodes of predetermined size; 2. a primarily nitric acid (HNO₃) or nitrate (NO₃) paste or solution of predetermined molality; 3. and a single cell.

FIG. 2 depicts a nitric acid (HNO₃) or nitrate (NO₃) battery distinguished by 1. an anode and a cathode or two electrodes of predetermined size; 2. a primarily nitric acid (HNO₃) or nitrate (NO₃) paste or solution of predetermined molality; 3. and separated cells.

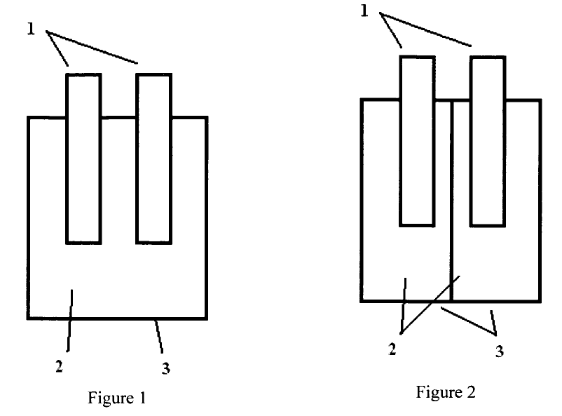

### DETAILED DESCRIPTION OF THE INVENTION

One embodiment of the invention is comprised of three major components: 1. an anode and a cathode or two electrodes of predetermined size; 2. a primarily nitric acid (HNO₃) or nitrate (NO₃) paste or solution of predetermined molality; 3. and a single cell. The second embodiment is comprised of 1. an anode and a cathode or two electrodes of predetermined size; 2. a primarily nitric acid (HNO₃) or nitrate (NO₃) paste or solution of predetermined molality; 3. and separated cells. An electrode or electrodes may protrude through the battery's container at corresponding endpoints of said electrode(s). Metallic or electrolyte buffers may be added to catalyze reactions in the present embodiment(s).

The batteries transfer electrons from one atom to another through redox reactions, resulting in a change in oxidation number or state and producing electrical work by running the electrons through an external circuit. NO₃⁻ is the conjugate base of nitric acid (HNO₃). Nitric acid is classified as an oxoacid because it contains oxygen and one other element, has at least one hydrogen atom bound to oxygen, and forms an ion by the loss of one or more protons. The Liebig definition states that in a hydrogen-containing acid, the hydrogen may be replaced by metal, making them an excellent buffer in battery reactions. Similarly, salts are also involved in acid and base reactions through neutralization where salt and water are formed in reactions between acids and bases. (Meyers, R., 2003, p. 156).

1. An anode whose chemical reactions are, from charged to discharged:
[[Bi+3 HNO₃+3 H₂O═Bi(NO₃)₃+3 H₃O]]

2. A cathode whose chemical reactions are, from charged to discharged:
[[Bi₂O₃+6 HNO₃=2 Bi(NO₃)₃+3 H₂O]]

3. A buffer whose chemical reactions are, from charged to discharged:
Anode:
[[Bi₂+4 HNO₃+C₆H₁₀O₅═Bi₂HNO₃+C₆H₇(NO₂)₃O₅+H₂O]]
Cathode:
[[Bi₂O₃+4 HNO₃+C₆H₁₀O₅+4 H₃O═Bi₂O₂(NO₃)+C₆H₇(NO₂)₃O₅+H₂O]]
